(19) United States
(12) Patent Application Publication
(10) Pub. No.: US 2010/0096486 A1
(43) Pub. Date: Apr. 22, 2010

(54) SINGLE-PULL CABLE WINDING DEVICE

(76) Inventor: Hsien-Lin Yang, Taipei City (TW)

Correspondence Address: LEONG C LEI, PMB # 1008, 1867 YGNACIO VALLEY ROAD, WALNUT CREEK, CA, 94598, US

(21) Appl. No.: 12/253,240

(22) Filed: Oct. 17, 2008

(51) Int. Cl. H02G 11/02; B65H 75/44; B65H 75/38

(52) U.S. Cl. 242/371; 191/12.4

(57) ABSTRACT

A cable winding device includes a top cover mounted to a bottom cover to interpose therebetween a rotary cable winding hub that defines between top and bottom frames a circumferential slot for winding up a cable therein. The top frame forms a space receiving therein a roll-up spring that provides a biasing force to the cable winding hub for winding up the cable. The bottom frame forms a recess fit over a raised fixing base extending from the bottom cover and forming multiple tracks that have a stop end for cooperating a limiting groove defined in the fixing base to properly retain the cable winding hub for each turn of rotation of the cable winding hub in extending the cable.

### TECHNICAL FIELD OF THE INVENTION

The present invention generally relates to a single-pull cable winding device that aims to improve and make a breakthrough of the conventional cable winding solution for power cables or signal cables, and in particular to a construction that allows for unidirectional, multiple-staged positioning, extension/retraction and uses an arrangement of conductors to have a mated external device in direct electrical connection with the cable winding device and allows the cable winding device to be concealed in and serving as a part of the external device to function as a power cable or a signal cable of the external device, whereby a cable winding device that features single directional extension retraction and concealability is provided.

In accordance with the present invention, the cable winding device is comprised of two portions, one being a unidirectional and multiple-staged cable extension/retraction structure, and the other being the arrangement of conductors for power and signal.

The unidirectional and multiple-staged cable extension/retraction structure allows a single extension cable to determine a length of extension and/or roll-up in accordance with the number of turns of rotation of a circumferential slot of a cable winding hub and the extension cable has a leading end extending into the cable winding hub to get into a bottom frame for connection with positive-electrode and negative-electrode conductor plates fixed therein with the positive-electrode and negative-electrode conductor plates corresponding to positive and negative ring electrodes formed on a surface of a circuit board to form constant-pressurization engagements therebetween, so as to transmit power or signal. The cable winding hub has a top frame that forming an internal space for receiving the winding of a roll-up spring therein for housing and protection purposes, which provides an opposite-direction resisting force to the extension cable to provide a mechanical power for re-winding and returning of the extension cable.

When the cable winding device is operated to extend or wind up the extension cable, the cable winding hub contained therein is caused to rotate in a forward or backward direction for simultaneously setting the roll-up spring inside the top frame in a released or tensioned wind-up condition with the positive-electrode and negative-electrode conductor plates arranged in the bottom frame of the cable winding hub positioned in correspondence with positive and negative ring electrodes located thereunder by means of flexible resiliency to ensure constant-pressurization engagement therebetween without being affected by the rotation of the cable winding hub so as to maintain electrical engagement between the extension cable and the circuit board for transmission of power and signal.

The cable winding hub of the present invention uses the spring force of the roll-up spring as a main power for extending and winding up the extension cable, and positioning that can be realized in the mechanism means an efficiently effected positioning mechanism when the charge cable is extended, which provides not only the capability of “one-time fast rewinding and returning”, but also a stepwise “positioning” function for subsequent extension of the extension cable after the cable has been positioned. Such an operation is realized through a track structure formed in a surface of a recess defined in the bottom frame of the cable winding hub that opposes a fixing base of the bottom cover and a positioning bead, whereby such a structure provides an “enclosed and limiting” configuration that is concealed and internally and stably arranged to completely overcome the gap problems of the tracks that cause forced disengagement of the positioning bead in the course of high speed rotation of the cable winding hub.

The arrangement of the conductors of the extension cable is realized by engagement of the positive-electrode and negative-electrode conductor plates that are connected to a leading end of the extension cable with positive and negative (inner and outer) ring electrodes of a circuit board to provide constant pressurization engagement therebetween. The leading end of the extension cable extends downward to get into the internal space of the bottom frame of the cable winding hub and fixed by an extension cable fixing slot, the positive and negative terminals of the extension cable being respectively connected to the positive and negative ring electrodes that are on different concentric circles to realize connection with the positive and negative (inner and outer) ring electrodes of the circuit board. Further, the circuit board has an extension that can realize transmission of power or signal through a cable connected thereto or a cable of the mated external device to allow the entire cable winding device to be concealed inside or serve as a part of the external device.

### DESCRIPTION OF THE PRIOR ART

All sorts of electrical appliances, computer peripherals or telecommunication peripherals need cables for transmission of power, data and signals. It is often that these appliances or peripheral devices simultaneously use multiple cables. This leads to problems associated with arrangement and organization of the cables, and such problems are troublesome to the general consumers. Most commonly observed problems are entangling of excessive length of cables or insufficiency of cable length. Further, the cables must be re-arranged and re-organized each time the electrical appliances of the computer systems are moved. This causes both psychological and physical discomfort for the consumers.

A known and commonly used solution to overcome the above problems is to fold and tied up the multiple folds of an over-length cable. This way, however, does not effectively solve the problems associated with un-organized outside appearance and cable entangling and knotting. An even severer problem is associated with safety for folding a cable may eventually lead to damage of the cable after a long term use, and affecting the safety and transmission of power and signal. Thus, the present invention aims to provide a solution to the above problems of extension cable in order to ensure high transmission quality, high performance, safety, and convenience.

Heretofore, a cable winding device that uses a steel ball to work with a spare length of cable, wherein a cable winding hub receives therein a roll-up spring to provide a main power for winding up and returning an extension cable. However, to ensure that electrical connection can be maintained at a terminal of the extension cable to effect transmission of power and signal, the extension cable of the conventional cable winding device is divided into a primary cable that is extendable and a spare cable that maintains electrical connection when the primary cable is extended or retracted. This can be found in U.S. Pat. No. 6,871,812 B1.

The conventional cable winding device uses an open type steel ball sliding mechanism and to provide positioning of the steel ball, a bottom of a cable winding hub forms a track to allow for reciprocal motion of the ball for engagement/disengagement for positioning.

Such a conventional structure of the conventional cable winding device that employs steel ball positioning and a spare length of cable is only applicable to signal transmission cables of small gauges for the previously mentioned parts are all small-sized parts. Thus, such a device is generally not suitable for power applications. This, together with the attempt to provide a single-pull configuration, makes the whole structure impractical and illogical. Although the known cable winding device uses a single cable with an end of the cable designated for connection with an external device, yet in the course of cable extension, a spare length of cable is required, leading to unnecessary risk of flaw product and burdens of cost, and eventually deteriorating marketability.

Apparently, the understanding of the conventional structure of the cable winding device reveals the following disadvantages:

(1) In the conventional cable winding device, since the steel ball moves in the tracks to effect engagement and disengagement, as well as high speed rolling, considering the tracks themselves, precision and slight abrasion/wear occurring in practical uses are of significant influence on the service life. Also, the steel positioning ball of the conventional cable winding device is of a non-enclosed, open arrangement between the cable winding hub and the cover and no protective or constraining means is provided, whereby once the cable winding hub undergoes eccentric rotation or if precision of the tracks is poor or if slight abrasion/wear occurs, the steel ball may get off the tracks or loss the function of engagement, leading poor service life and durability that are unacceptable to the general consumers.

2. The steel ball moves in the tracks to roll and to perform engagement/disengagement, of which excellent operation is dependent upon the matching precision between the steel ball and the tracks. Apparently, high precision is a critical factor for the conventional cable winding device and this leads to increasing costs of development and assembling.

3. For the conventional cable winding device, a substantial length of spare cable is needed in order to maintain electrical connection after being pulled outward. Such a length of the spare cable makes a great economic burden and may also raise problems associated with cable entangling and undesired resistance when the extension cable presents tensioned/released conditions in extension/retraction thereof, making the operation impractical and poor.

### SUMMARY OF THE INVENTION

In view of the above, the present invention provides a single-pull cable winding device, comprising, in construction thereof, a top cover, a roll-up spring, a rotary cable winding hub, a positioning bead, an extension cable, a circuit board, and a bottom cover, wherein the roll-up spring is wound up and received in an internal space defined in a top frame of the cable winding hub and provides an opposite-direction resisting force to the extension cable wound around a circumferential slot of the cable winding hub so as to provide a mechanical power source for extending or rewinding the extension cable. Further, the roll-up spring has an internal central terminal that is fit and fixed in a slit defined in a central axle extending from the top cover and an external terminal forming a hook fit in and fixed to a notch defined in a circumferential wall of the cable winding hub, whereby the roll-up spring is selectively set in a tensioned wind-up condition or a released condition depending upon the rotation of the cable winding hub in either the forward direction or the backward direction.

The circumferential slot of the cable winding hub functions to wind up the extension cable in such a way that an internal end of the extension cable first extends into an internal space formed in the bottom frame of the cable winding hub and is fixed by an extension cable fixing slot. Positive and negative terminals of the charge cable are then respectively connected to positive-electrode and negative-electrode conductor plates to form connection for transmission of power and signal. Further, the positive-electrode and negative-electrode conductor plates are set in locations that are at different concentric circles to provide a relative distance therebetween to be respectively corresponding to positive and negative (inner and outer) ring electrodes and thus form respective constant-pressurization engagements therebetween.

The circuit board serves as a major component that provides transmission of power or signal between the cable winding device and an external mated device, wherein the circuit board has an extension that realizes connection with the circuit board for transmission of power and signal via a separate cable or a cable from the external device so as to establish electrical connection between the external device and the cable winding device. As such, the cable winding device can be concealed inside the external device or serving as constituent parts of the external device.

Based on the principle and construction of the present invention, the cable winding device of the present invention provides a positioning mechanism that is realized with a track structure formed in a surface of a recess of a bottom frame of cable winding hub that opposes a fixing base of a bottom cover and a positioning bead arrangement therebetween to form an “enclosed and limiting” configuration. Further, based on the extension and rewinding of the extension cable, the cable winding hub is driven to do forward and backward rotations, which simultaneously drive the positioning bead to alternately effect engagement and disengagement for locking and unlocking.

With such a construction, the present invention provides operational features of “single-pull” and “multiple stage positioning” by means of a roll-up spring, a cable winding hub, a positioning bead, and an arrangement of conductors, together with the operation of extension and retraction of an extension cable, whereby drawbacks associated with the conventional steel ball positioning and the need of spare cable can be eliminated and various additional functions may also be provided.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a cable winding device constructed in accordance with a preferred embodiment of the present invention.

FIG. 2 is an exploded view of the cable winding device of the present invention.

FIG. 3 is a perspective view of a cable winding hub of the present invention set in a reversed condition.

FIG. 4 is a plan view of the cable winding hub of the present invention in the reversed condition.

FIG. 5 is a cross-sectional view illustrating the operation of the cable winding device of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

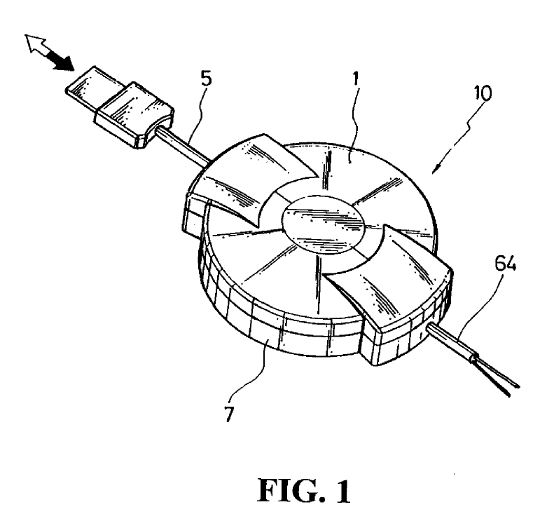

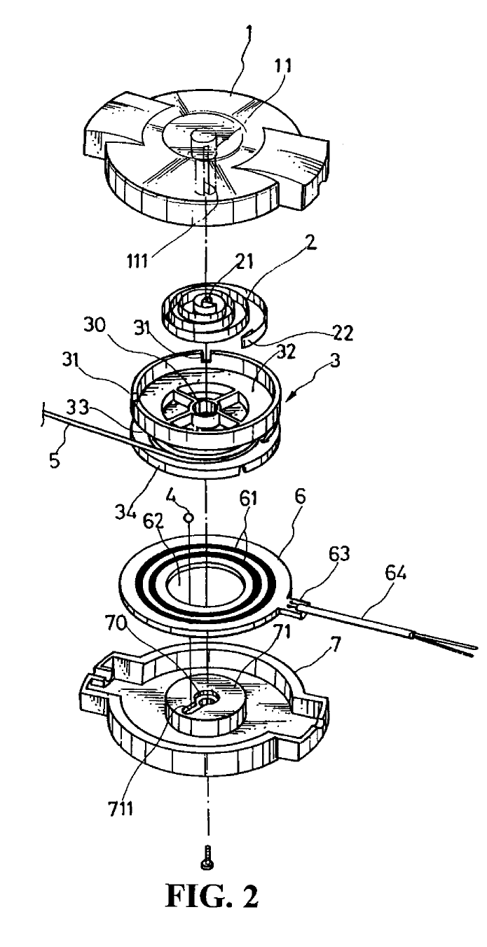

With reference to FIGS. 1 and 2, the present invention provides a single-pull cable winding device, broadly designated at 10, which has a construction generally composed of a top cover 1, a roll-up spring 2, a rotary cable winding hub 3, a positioning bead 4, an extension cable 5, a circuit board 6, and a bottom cover 7. The roll-up spring 2 has an internal central terminal 21 that is fit in and fixed to a slit 111 defined in a central axle 11 extending from the top cover 1 and an external terminal forming a hook 22 fit in and fixed to a notch 31 defined in a circumferential wall of the cable winding hub 3, whereby the roll-up spring 2 is selectively set in a windup tensioned condition or a released condition depending upon the rotation of the cable winding hub 3 in either the forward direction or the backward direction for providing a mechanical power for rolling up and returning the extension cable 5.

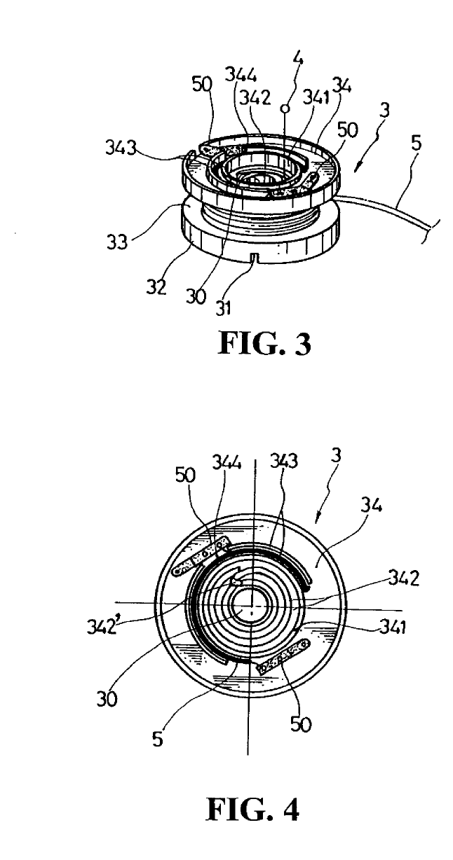

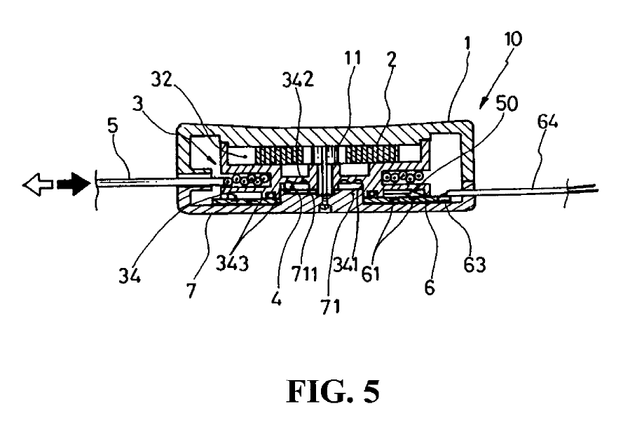

Also referring to FIGS. 3 and 5, the cable winding hub 3 is comprised of a top frame 32, a circumferential slot 33, and a bottom frame 34. The top frame 32 forms an internal space for receiving and allowing the tensioning/releasing of the roll-up spring 2 therein. The circumferential slot 33 is defined between the top frame 32 and the bottom frame 34 that provides a space for winding up the extension cable 5 therein. The bottom frame 34 forms an internal space that receives therein positive-electrode and negative-electrode conductor plates 50 mounted to a top wall thereof and the bottom frame 34 further defines, in the top wall thereof, a recess 341 having a top surface forming a track structure 342 corresponding to and opposing a fixing base 71 that is raised from an inside surface of the bottom cover 7 with the fixing base 71 housed in the recess 341, whereby the positioning bead 4 that is arranged between the track structure 342 and the fixing base 91 presents an “enclosed and limiting” configuration.

Next, the central axle 11 extending from the top cover 1 penetrates through a central bore 30 defined in the cable winding hub 3 and is further fit into a fixing hole 70 defined in the fixing base 71 of the bottom cover 7. In this way, the central axle 11 of the top cover 1 is more stably supported and the cable winding hub 3 may be supported by the central axle 11 to carry out high-speed forward and backward rotations. Further, the track structure 342 that is formed in the recess 341 of the bottom frame 34 is of a multiple track arrangement with a stop end 342′ formed in the tracks. The positioning bead 4 is set in a limiting groove 711 defined in a top surface of the fixing base 71 so that the positioning bead 4 is only allowed to do reciprocal motion along the limiting groove 711. Thus, each time when the extension cable 5 is pulled to cause the cable winding hub 3 to make rotation of a turn, the stop end 342′ and the limiting groove 711 cooperate with each other to induce a positioning operation once. When the extension cable 5 extends or rewinds in excess of the extent that the current positioning operation allows for the current turn, a new, next positioning operation may be performed for the next rotation turn, whereby the extension cable 5 of the cable winding device 10 features the function of multiple-staged extension/retraction and positioning.

Also referring to FIG. 4, the extension cable 5 within the circumferential slot 33 of the cable winding hub 3 is set in such a way that an internal end of the extension cable 5 initially extends into the internal space of the bottom frame 34 of the cable winding hub 3 and is fixed by a dual-ring extension cable fixing slot 343 formed in the bottom frame 34. Positive and negative terminals of the extension cable 5 then extend through an opening 344 to respectively connect to the positive-electrode and negative-electrode conductor plates 50 that are fixed in position in advance to form connection for conduction of power. Further, the positive-electrode and negative-electrode conductor plates 50 are set in locations that are at different concentric circles, so that when the positive-electrode and negative-electrode conductor plates 50 are set to face the circuit board 6, the positive-electrode and negative-electrode conductor plates 50 are set to correspond, in position, to positive and negative (inner and outer) ring electrodes 61 formed on a surface of the circuit board 6 so that the positive-electrode and negative-electrode conductor plates 50 form respective constant-pressurization engagements with the positive and negative ring electrodes 61, whereby the extension and/or rewinding of the extension cable 5 following the rotation of the cable winding hub 3 is not affected and constant transmission of power supply or signal is ensured.

Returning back to FIG. 2 and also referring to FIG. 5, the circuit board 6 forms a fitting bore 62 that is fit over and positioned on the fixing base 71 of the bottom cover 7 with the positive and negative (inner and outer) ring electrodes 61 forming respective constant-pressurization engagements with the positive-electrode and negative-electrode conductor plates 50 of the bottom frame 34. Thus, the power can be supplied through the extension cable 5 when the extension cable 5 is either pulled outward or rewound to roll up.

The circuit board 6 of the present invention serves as a major component that provides transmission of power or signal between the cable winding device 10 and an external mated device, wherein the circuit board 6 has an extension 63 that realizes connection with the circuit board 6 for transmission of power and signal via a separate cable or a cable from the external device so as to establish electrical connection between the external device and the cable winding device 10. As such, the cable winding device 10 can be concealed inside the external device or serving as constituent parts of the external device.

Without departing the general principle of the present invention, the previously mentioned constituent components, including the roll-up spring 2, the cable winding hub 3, the positioning bead 4, the extension cable 5, and the circuit board 6, can be directly arranged inside the external device and fixed by for example upper and lower casing members of the external device so as to serve as constituent parts of the external device.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cable winding device comprising a top cover, a roll-up spring, a rotary cable winding hub, a positioning bead, an extension cable, a circuit board, and a bottom cover, wherein:
the top cover forms an extended central axle penetrating through a central bore defined in the cable winding hub and fit into a fixing hole defined in a fixing base of the bottom cover, the central axle forming a slit in which an internal central terminal of the roll-up spring is fit and fixed;
the roll-up spring is received in an internal space formed in a top frame of the cable winding hub and has the internal central terminal fit in the slit defined in the central axle of the top cover and an external terminal forming a hook fit in and fixed to a notch defined in a circumferential wall of the cable winding hub, so that the roll-up spring is selectively set in a windup tensioned condition or a released condition according to the rotation of the cable winding hub in a forward direction or a backward direction for providing a mechanical power for rolling up and returning the extension cable;
the cable winding hub forms the central bore for receiving the central axle of the top cover penetrating therethrough and the cable winding hub comprises a top frame, a circumferential slot, and a bottom frame, in which the top frame forms the internal space for receiving the roll-up spring therein, the circumferential slot is defined between the top frame and the bottom frame to provide a space for winding up the extension cable therein, and the bottom frame forms an internal space that receives therein positive-electrode and negative-electrode conductor plates and further forms a dual-ring extension cable fixing slot, the bottom frame defining a recess having a surface forming a track structure of a multiple track arrangement, the multiple tracks having a stop end and forming an enclosed and limiting configuration with the fixing base of the bottom cover;
the positioning bead is set between the track structure defined in the surface of the recess of the bottom frame of the cable winding hub and a limiting groove defined in a surface of the fixing base of the bottom cover so that the positioning bead is only allowed to do reciprocal motion along the limiting groove;
the extension cable is wound around the circumferential slot of the cable winding hub and has an internal end extending into the internal space formed in the bottom frame of the cable winding hub to be fixed by the dual-ring extension cable fixing slot, positive and negative terminals of the extension cable being respectively connected to the positive-electrode and negative-electrode conductor plates that are fixed in position in advance to form connection for transmission of power;
the circuit board forms a fitting bore fit over and positioned on the fixing base that is raised from the power adaptor bottom cover and having a surface forming positive and negative ring electrodes that are located in correspondence to the positive-electrode and negative-electrode conductor plates of the bottom frame of the cable winding hub for forming respective constant-pressurization engagements therewith; and
the bottom cover forms the raised fixing base for being fit into and positioning the circuit board, the fixing base allowing the recess of the bottom frame of the cable winding hub to fit thereon and having a surface forming the limiting groove, and also forms a fixing hole receiving the central axle of the top cover to fit therein.

2. The cable winding device according to claim 1, wherein the positive-electrode and negative-electrode conductor plates received in the internal space formed in the lower frame of the cable winding hub are set in locations that are at different concentric circles.

3. The cable winding device according to claim 1, wherein the cable winding device is integrated with a mated external device, the top cover and the bottom cover of the cable winding device being substituted by upper and lower housing members of the external device for coupling the roll-up spring, the cable winding hub, the positioning bead, the extension cable, and the circuit board therein for also serving as constituent components of the external device.
